(19) United States
(12) Patent Application Publication
(10) Pub. No.: US 2011/0256871 A1
(43) Pub. Date: Oct. 20, 2011

(54) Mobility Influenced by Radio Uplink Failure

(75) Inventors: DAVID J. COOPER, WATERLOOVILLE (GB); SEAN M. FERRIS, GYEONGJU CITY (KR); YUHONG LIANG, BASINGSTOKE (GB)

(73) Assignee: MOTOROLA, INC., Schaumburg, IL (US)

(21) Appl. No.: 12/762,622

(22) Filed: Apr. 19, 2010

(51) Int. Cl. H04W 36/30

(52) U.S. Cl. 455/436

(57) ABSTRACT

An intelligent subscriber and method of the subscriber roaming between base stations is presented. An unexpected uplink, such as a request to initiate communication, a SMS communication or request to change talkgroup, is transmitted to a base station. When a predetermined number of such uplinks remain unacknowledged by the base station, the subscriber determines that terminal failure of the base station has occurred. An ordered list of available base stations able to serve the subscriber is maintained in subscriber memory. The ordering is based on service level and within each service level by radio measurements. The list is manipulated such that the service level of the original base station is minimized A new base station is selected using the manipulated ordered list. The service level of the original base station is then restored. A communication is sent to an external host to record information about the terminal failure.

TECHNICAL FIELD

The present application relates generally to a communication method and in particular to a method for a subscriber to automatically switch base stations when a terminal uplink failure of the base station serving the subscriber occurs.

### BACKGROUND

Communication systems in which subscribers such as cellular telephones, personal digital assistants (PDAs) and push-to-talk (PTT) devices can communicate via a network infrastructure. The infrastructure, in turn, generally includes various fixed installations such as access points and base transceiver stations (also referred to as base stations). Each base station has one or more transceivers which serve subscribers in a given region or area, known as a ‘cell’, by radio communication. The cells of neighboring base stations often overlap, allowing for roaming between the base stations as the subscriber travels within a particular cell. Signals sent from the subscriber to its serving base station are known as ‘uplink’ signals (also referred to herein as uplinks) and those sent from the base station to the subscriber are known as ‘downlink’ signals (also referred to herein as downlinks). Uplinks and downlinks may have different characteristics, such as being sent on different channels or having different types of modulation and thus may use different types of encoding and decoding schemes.

Generally, it is desirable for a subscriber to be served by the base station that can provide the best signal strength, i.e. the base station that can send and receive the strongest signals to and from the subscriber. Roaming between base stations occurs when the signal strength of the serving base station drops below a predetermined threshold. Generally, communication processes occur through a collaborative process in which the subscriber and base station signal each other and provide a layer 2 (i.e., the data link layer of the Open Systems Interconnection (OSI) communication model) acknowledgment that the signal has been received. By using acknowledgements, the signal quality of communications between the subscriber and base station can be enhanced as the transmitting device can be assured that a particular signal has been received and is being processed by the receiving device.

Under certain conditions, such as clashes between subscriber uplinks at the base station, interference on the uplink or an improperly balanced RF configuration, the uplink may not reach the base station and thus the subscriber will be unable to access the infrastructure. In general, the transmit power of a subscriber may be adjusted based upon the signal strength of the serving base station and/or system configurable settings to ensure that each cell is optimized. If correctly adjusted (i.e., the RF configuration is properly balanced), the signal strength from the subscriber is of sufficient strength to be received by the base station when the signal received from the base station is sufficient to prevent the subscriber from trying to switch to a different base station. In any case, if the subscriber does not receive an acknowledgement from the base station, the subscriber repeatedly attempts to resend the signal to the base station. In communication systems such as the TErrestrial Trucked RAdio (TETRA), mobility is based upon the downlink signal strength. Thus, if communication between the subscriber and base station fails, the subscriber does not have the intelligence to move to another site where it may access the infrastructure more reliably.

Although the base station may be able to inform the subscriber of an uplink failure if an uplink does not arrive in a particular time period, this is only possible if the base station and the subscriber are already in communication and the base station expects an uplink from the subscriber. Such a technique is unable to be used if the uplink is unexpected—e.g., the subscriber has not yet initiated communication to the base station, of short message service (SMS) signals or a request by the subscriber to change talkgroups. Thus, if unexpected uplinks from the subscriber fail to reach or to be decoded by the base station, the base station cannot inform the subscriber of the failure. This technique can further take a substantial amount of time before the subscriber is informed by the base station that the uplink has not been received.

It would thus be beneficial to impart intelligence to the subscriber to allow the subscriber to select other base stations and access the infrastructure when terminal failure of a serving base station to an unexpected uplink occurs.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an embodiment of a communication system.

FIG. 2 illustrates an embodiment of a subscriber.

FIG. 3 shows a timing diagram of an embodiment of a subscriber switching from one base station to another base station.

FIG. 4 shows a signal level diagram of an embodiment of a subscriber switching between two base stations.

FIG. 5 shows an embodiment of a method of a subscriber selecting a new base station.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of the embodiments of shown.

The apparatus and method components have been represented where appropriate by conventional symbols in the drawings, showing only those specific details that are pertinent to understanding the embodiments shown so as not to obscure the disclosure with details that will be readily apparent to those of ordinary skill in the art having the benefit of the description herein. Other elements, such as those known to one of skill in the art, may thus be present.

### DETAILED DESCRIPTION

Before describing in detail the various embodiments, it should be observed that such embodiments reside primarily in providing intelligence to a subscriber such that the subscriber is able to select another base station when terminal failure of the original base station to an unexpected uplink occurs. This can be accomplished by providing a dedicated counter in the subscriber to determine whether a predetermined number of uplink attempts to the serving base station have been made by the subscriber and, if so, selecting a new base station without permitting or reducing the possibility of the subscriber selecting the original base station. Information regarding the terminal failure of the base station can be recorded in the subscriber and transmitted to a host in the infrastructure for diagnostic or maintenance purposes. As used herein, a subscriber is an end user device such as a cellular telephone, PDA, or PTT device. Also, in all embodiments described herein, because of the nature of the uplink (also referred to herein as a call) from the subscriber, the base station has no indication of when or if the next call from the subscriber will arrive. A request to register the subscriber with the base station is an example of such a call.

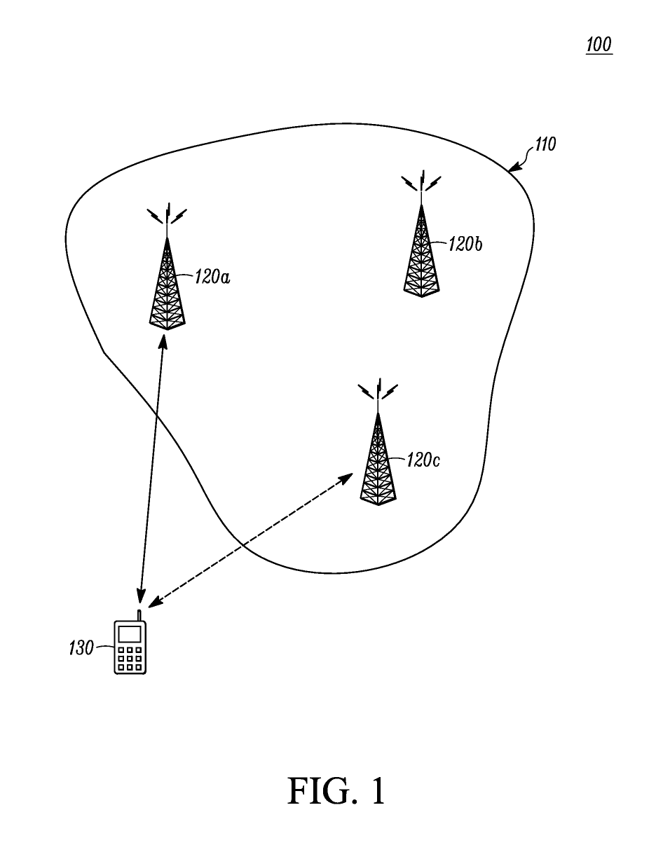

FIG. 1 illustrates a network 100 that includes an infrastructure 110. There are many distributed elements in the infrastructure 110, some local to each other others disposed geographically distant from each other. Such elements include base stations 120a, 120b, 120c, of which only three are shown for convenience. The base stations 120a, 120b, 120c provide connectivity for a subscriber 130 disposed within the coverage area serviced by the base stations 120a, 120b, 120c to other devices either in the same coverage area or in a different coverage area through the infrastructure 110. The subscriber 130 changes its connection to the infrastructure 110 from one base station 120a to another base station 120b as the conditions described below change.

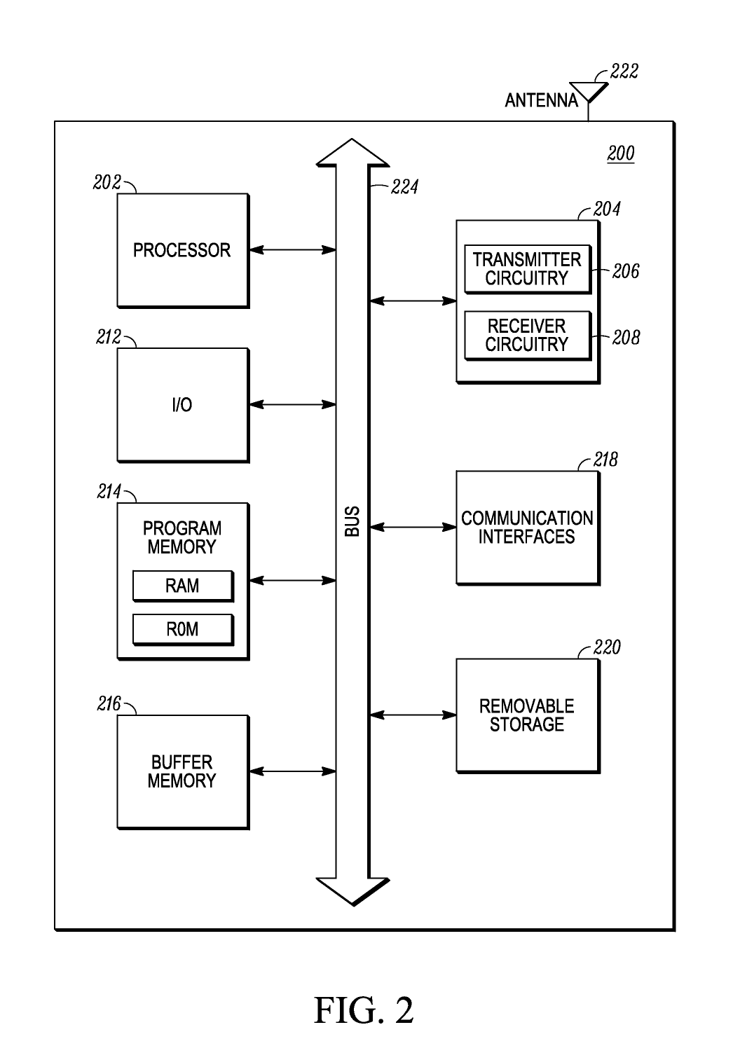

An embodiment of the subscriber is shown in the block diagram of FIG. 2. The subscriber 200 contains, among other components, a processor 202, a transceiver 204 including transmitter circuitry 206 and receiver circuitry 208, an antenna 222, I/O devices 212, a program memory 214, a buffer memory 216, one or more communication interfaces 218, and a removable storage 220. The subscriber 200 is preferably an integrated unit containing at least all the elements depicted in FIG. 2, as well as any other element necessary for the subscriber 200 to perform its electronic functions. The electronic elements are connected by a bus 224.

The processor 202 includes one or more microprocessors, microcontrollers, DSPs, state machines, logic circuitry, or any other device or devices that process information based on operational or programming instructions. Such operational or programming instructions are stored in the program memory 214 and may include instructions such as estimation and correction of a received signal, encryption/decryption, and decisions about which base station to use as described herein that are executed by the processor 202. The program memory 214 may be an IC memory chip containing any form of random access memory (RAM) or read only memory (ROM), a floppy disk, a compact disk (CD) ROM, a hard disk drive, a digital video disk (DVD), a flash memory card or any other medium for storing digital information. One of ordinary skill in the art will recognize that when the processor 202 has one or more of its functions performed by a state machine or logic circuitry, the memory 214 containing the corresponding operational instructions may be embedded within the state machine or logic circuitry. The operations performed by the processor 202 and the rest of the subscriber 200 are described in detail below.

The transmitter circuitry 206 and the receiver circuitry 208 enable the subscriber 200 to respectively transmit and receive communication signals. In this regard, the transmitter circuitry 206 and the receiver circuitry 208 include appropriate circuitry to enable wireless transmissions. The implementations of the transmitter circuitry 206 and the receiver circuitry 208 depend on the implementation of the subscriber 200 and the devices with which it is to communicate. For example, the transmitter and receiver circuitry 206, 208 may be implemented as part of the communication device hardware and software architecture in accordance with known techniques. One of ordinary skill in the art will recognize that most, if not all, of the functions of the transmitter or receiver circuitry 206, 208 may be implemented in a processor, such as the processor 202. However, the processor 202, the transmitter circuitry 206, and the receiver circuitry 208 have been artificially partitioned herein to facilitate a better understanding. The buffer memory 216 may be any form of volatile memory, such as RAM, and is used for temporarily storing received information.

The subscriber 200 may also contain a variety of I/O devices such as a keyboard with alpha-numeric keys, a display (e.g., LED, OELD) that displays information about the subscriber, a PTT button, a channel selector knob to select a particular frequency for transmission/reception, soft and/or hard keys, touch screen, jog wheel, a microphone, and a speaker.

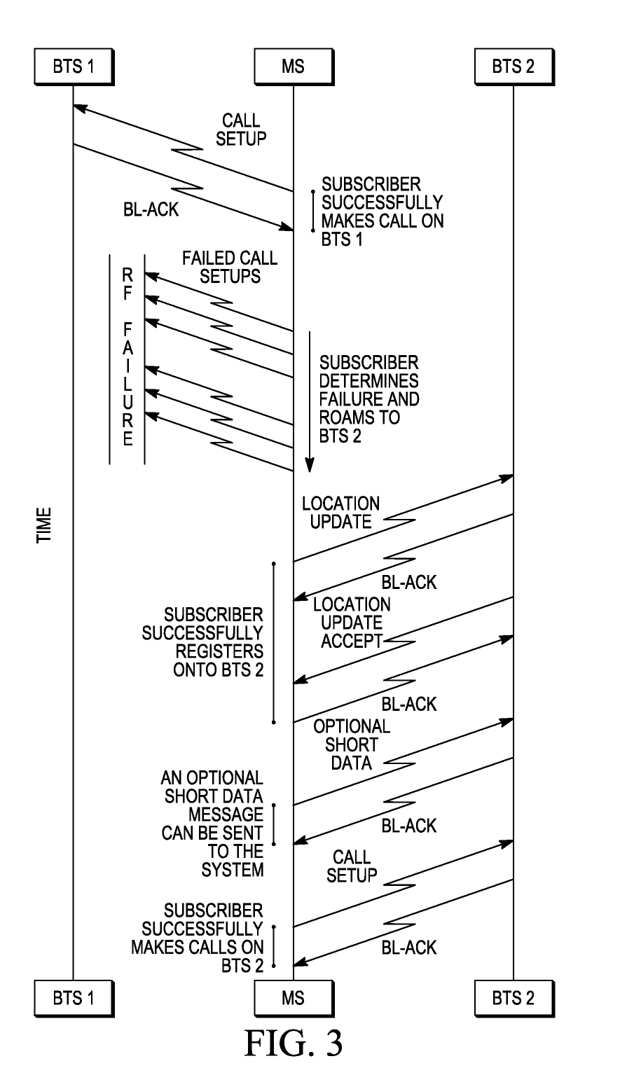

As described previously, if the subscriber attempts to access the communication system but cannot because of an uplink failure, it generally continues to repeat its attempts. It is thus desirable to add intelligence to the subscriber to allow the subscriber to actively look for other base stations that the subscriber may be able to access more reliably. As shown in the signal diagram of FIG. 3, for example, the system contains a subscriber (mobile station MS) and two base stations (BTS1 and BTS2). In the embodiment shown, the subscriber initially successfully communicates (Call Setup) with the original base station (BTS1) and receives an acknowledgment (BL-ACK) from the first base station for each communication sent to the original base station. Each communication is either data signals such as SMS signals or control signals such as a request to change the talkgroup to which the subscriber currently subscribes.

At some point, the subscriber suffers a series of uplink failures. This is to say that the subscriber attempts to communicate with the original base station but does not receive an acknowledgment from the original base station. This can be due to, for example, congestion or clashes between messages from different subscribers at the first base station, causing unacceptable delays or eliminating in accessing the original base station, or interference or other environmental effects. After a predetermined set of conditions have been reached, the subscriber determines that the uplink failure is terminal and roams to the new base station (BTS2). More specifically, the subscriber registers with the new base station, sending location and identity information to the new base station and receiving an acceptance from the new base station to proceed to communicate with the new base station. An acknowledgment is sent by the receiving devices both for the information to the new base station and the return acceptance by the new base station.

After acceptance by the new base station, the subscriber may send a SMS or similar communication to a host or fault recorder located within the infrastructure to alert the system that a terminal uplink failure has occurred. The message sent may include various details surrounding the problems experienced by the subscriber such as that a terminal uplink fault occurred, the base station at which the terminal uplink failure occurred, the time of the occurrence and other information that the system may desire. Such information could assist engineers in identifying problem sites as well as aiding in diagnostics and maintenance. The subscriber then proceeds to make calls using the new base station.

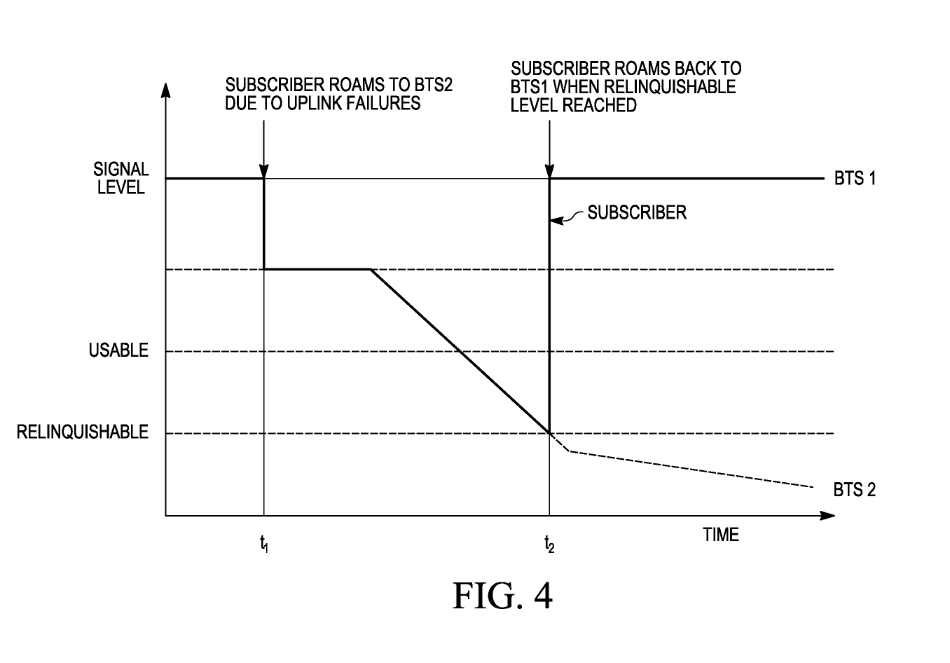

FIG. 4 shows an example of signal level plot for various base stations in a system as well as tracing the path of a subscriber when the serving base station fails temporarily. In this example, only two base stations are able to serve the subscriber, but of course more than two base stations may be able to serve the subscriber in other embodiments. The subscriber is initially served by the first base station. At time t₁, the subscriber experiences a series of uplink failures when trying to access the original base station. Once the predetermined conditions have been reached, the subscriber terminates attempts to access the original base station, selects and becomes affiliated with the new base station (which is above the usable level), and starts sending uplinks to the new base station. Although the signal strength of the original base station is always greater than the new base station, the subscriber does not attempt to reselect the original base station when selecting (or roaming to) the new base station and does not attempt to roam back to the original base station until the signal quality of the new base station degrades to the relinquishable level at time t₂.

When more than two base stations are able to serve the subscriber, the subscriber maintains an ordered list of available base stations between most and least desirable. The subscriber roams to the highest ranked base station, which depends on both one or more radio measurements as well as a relative service level of the base station. The radio measurement has three levels, relinquishable, usable and improvable, and depends on signal strength (the received signal strength indicator RSSI or signal to noise S/N ratio). A base station is usable when the downlink signal strength exceeds a first threshold plus a second threshold, improvable when the downlink signal strength falls below a third threshold and the downlink signal strength of another base station is higher than the current downlink signal strength by a fourth threshold, and relinquishable when the downlink signal strength falls below the first threshold and there is another base station whose signal strength is higher than the current downlink signal strength by the second threshold. The relative service level can be better, worse or the same and depends on a variety of elements such as services provided (e.g., voice/video), trunking state, subscriber class, security, home location, boundary and load. Trunking state can include wide area or local area states, e.g. whether the base station is able to communicate with the rest of the network or is working in isolation. Subscriber class can be used to direct subscribers to preferred or highly preferred sites.

More specifically, to determine which base station to use, in one embodiment the subscriber selects the base station whose service level is best (i.e., provides all of the desired services) and then whose signal is at least usable. If multiple base stations satisfy these criteria, the subscriber selects the base station with the best signal level. If the service level of the neighboring base station is equal to that of the currently serving base station the subscriber does not necessarily reselect to a usable neighboring base station if the currently serving base station is usable but not improvable. If the currently serving base station becomes relinquishable, the subscriber selects another base station, for example either immediately or at the next predetermined time period when reselection is to occur. The subscriber may also select another base station even before the currently serving base station becomes relinquishable if the currently serving base station becomes improvable so long as the service level of the other base station is at least equal to that of the currently serving base station. An improvable base station is thus ranked higher than a usable base station as a usable base station only indicates that the signal from a neighboring base station is above a usable signal strength while an improvable base station indicates that the signal from the neighboring base station has a higher signal strength than the current serving base station. More specifically, the signal of the neighboring base station is high enough so that the currently serving base station becomes improvable.

Further, the subscriber may also select a neighboring base station even when the currently serving base station is usable if the service level of the neighboring base station is better than that of the currently serving base station. This is true if the subscriber is idle, but may vary depending on whether or not the subscriber is involved in a circuit mode call. The base stations are contained within an ordered list in memory of the subscriber, with the list being organized primarily by service level and then, within each service level by radio measurement. Thus, given base stations A, B, and C where base stations A and B are usable and base station C is improvable and where base stations A and C provide equal service levels better than or equal to that of the currently serving base station whereas base station B has a service level less that that of the currently serving base station, the ordered list in the subscriber in the described embodiment would be C, A, B. In another example, if base stations A and B are usable and base station C is improvable, base station A provides a better service level than that of the currently serving base station, and base stations B and C provide service levels equal to that of the currently serving base station, the ordered list in the subscriber in the described embodiment would be A, C, B.

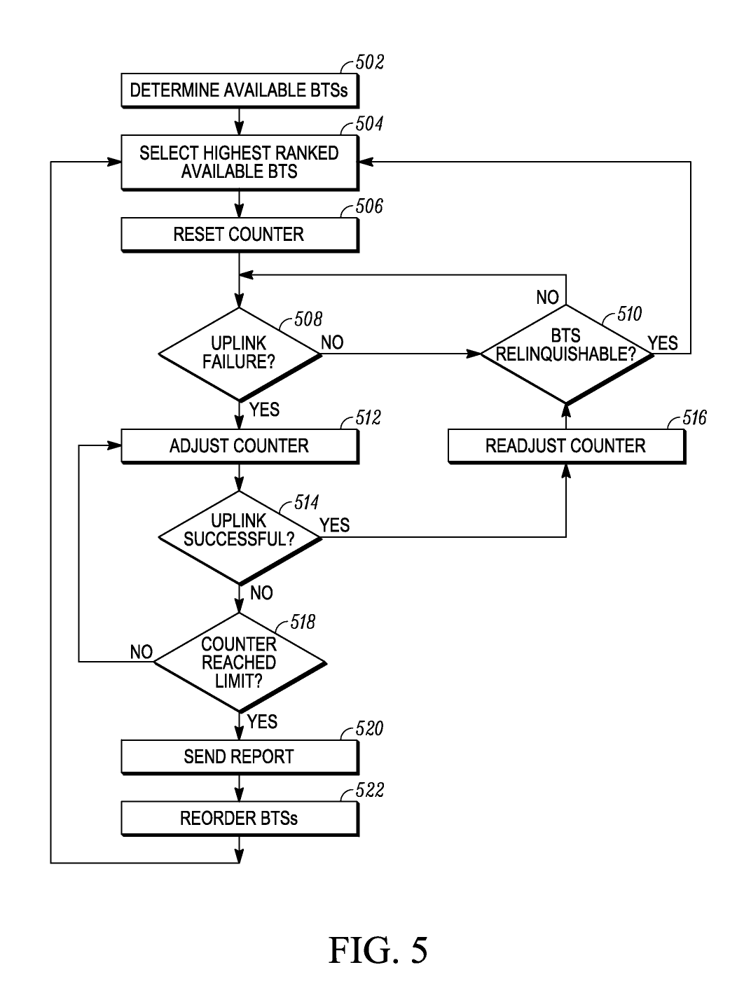

Such an embodiment is employed as shown in the flowchart of FIG. 5 for imparting roaming intelligence to the subscriber. At step 502, the subscriber scans for available base stations. This scanning is done intermittently and may use, for example, broadcast announcements from the various available base stations to determine the service levels and radio measurements. The subscriber, after gathering the base station information over a predetermined period of time, establishes an ordered list of base stations and selects (i.e., roams to) the most desirable base station in the list at step 504.

At step 506, the subscriber resets an uplink failure counter set to an initial value. The subscriber attempts to register or otherwise communicate with the selected base station. If the subscriber determines at step 508 that the uplink is successful (i.e., an acknowledgment is received from the selected base station after the subscriber has sent control or data information to the base station), the subscriber checks whether the base station is relinquishable at step 510. If the subscriber determines that the new base station is not relinquishable at step 510, the subscriber returns to step 508 and attempts to transmit the next set of data to the base station when the uplink is desired. If an uplink failure is determined to have occurred at step 508, the counter is adjusted at step 512 before the next uplink attempt. The counter can be adjusted by being either incremented or decremented from the initial value.

If at step 514 it is determined that the next uplink attempt is successful, the counter is readjusted at step 516. Specifically after at least one uplink failure and then a subsequent uplink success, the counter is adjusted in reverse for the success (although the step size of the adjustment for success may be different from that of the adjustment for failure). For example, if the counter was initialized to 0 and incremented by 1 each time an uplink failure occurred, if the subscriber experienced 5 uplink failures before succeeding, assuming that the counter limit was not reached, the counter would stand at 4 (or 3 if decremented by 2 for each success). After the counter is readjusted at step 516, the subscriber continues to step 510, in which the subscriber again checks whether the base station is relinquishable.

If it is determined that the next uplink attempt is unsuccessful at step 514, the subscriber determines whether the counter has reached its limit (i.e., reached its maximum permitted value if being incremented or reduced to its minimum permitted value if being decremented) at step 518. If it is determined at step 518 that the counter has not reached its limit, the process returns to step 512, where the counter is adjusted before the next uplink attempt.

If it is determined at step 518 that the counter has reached its limit, at step 520 a failure report may optionally be generated and/or sent to a host or fault recorder in the infrastructure. At this point the subscriber is suffering multi uplink failures, so the failure report may need to be stored until after it has switched to a new base station and then sent. The base stations are then reordered in the list at step 522 before the process returns to step 504, where a new base station is selected. As both the service level and radio measurements may change with time, the latest available information is used in the reordering. The current serving base station, for which the terminal uplink failure occurred, is deselected by the subscriber artificially resetting the service level of the current base station to lower than that of at least one of the other base stations.

In one embodiment, the service level of the current serving base station is set to the lowest possible level so that during reselection there is little chance, if any, of reselecting the same base station. After reselection, the service level of the original base station may be restored to its original value at some point so that it may again be selected. The subscriber may return the service level of the original base station to its original value after a preset, non time-based condition has been met, after a predetermined amount of time has elapsed, or a combination thereof.

The non time-based condition may be related to selection of the new base station or the next base station after the new base station. For example, restoration of the original value may occur immediately after the selection of the new base station or somewhat later, after the uplink to the new base station has been successful and the subscriber receives an acknowledgment from the new base station or after failure of the new base station but before selection of the next base station. Each of these embodiments permit reselection of the original base station if the new base station soon fails due to failure to acknowledge an uplink from the subscriber or the radio measurements of the new base station falls to the relinquishable level. The former case permits reselection of the original base station if the new base station also immediately fails, e.g., if the subscriber is provided with information indicating that (or if in the hope that) the terminal uplink failure of the original base station was caused by a short-term problem.

Alternatively, the restoration of the original service level of the base station may be purely time-based. That is, the subscriber may have a reselection timer that starts after reselection and after whose period has ended the service level of the original base station is restored to its original value. The period may be set, for example, to be greater than the mean historical time to correct failures in the base station or similar base stations (statistics may be retained in the memory of the subscriber) or to adjust to a time when less communication traffic is likely to exist on the original base station. In the latter case, if the subscriber suspects that the terminal uplink failure is due to clashes between subscribers, it may wait for a predetermined length of time (e.g., an hour) or until a predetermined time of day (e.g., 8 pm) before restoring the service level of the original base station to its original value.

In another embodiment, the service level of the original base station may not be restored to its original value until either all of the remaining base stations have been selected or until the last remaining base station with an acceptable service level has been selected. Additionally, the subscriber may retain in memory the number of terminal uplink failures (i.e., the number of times roaming resulted due to the counter reaching its limit) within one or more established time periods (e.g., 8 am-9 am) and within a predetermined recent period (e.g., the last several hours or days) for each base station. For this to occur, the base station will have to have been reselected by the subscriber at least once during the recent period. The time period may start after terminal failure of the base station or after selection of the new base station. If a base station appears to have repeated problems, the subscriber may deem it to be unreliable and artificially lower its service level for an extended period of time, such as the same length of time as the recent period. The shorter predetermined length of time above or the extended length of time may be adjusted dependent on the failure history of the base station. For example, if the original base station has terminally failed only once within the recent period, the length of time before the subscriber allows itself to roam back to the original base station may be shorter than if the original base station has terminally failed four or five times within the recent period.

On the other hand, if the subscriber determines that the currently serving base station is relinquishable at step 510, without having suffered terminal failure, it returns to step 504 where a new base station is selected (but without reordering the list by changing the service levels).

The method above allows the subscriber to select a reliable base station without degrading the subscriber's quality of service. The addition of intelligence in the subscriber for roaming to different base stations when a terminal uplink failure occurs may promote faster and more reliable communications. If for example the uplink failures are caused by clashes due to the base station being busy, spreading of the load across some of the neighboring base stations aids in reducing the congestion of the network.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure and Summary section are provided to allow the reader to quickly ascertain the nature of the technical disclosure. It is submitted with the understanding that neither will be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

Those skilled in the art will recognize that a wide variety of modifications, alterations, and combinations can be made with respect to the above described embodiments without departing from the spirit and scope of the invention and that such modifications, alterations, and combinations are to be viewed as being within the scope of the inventive concept. Thus, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims issuing from this application. The invention is defined solely by any claims issuing from this application and all equivalents of those issued claims.

1. A method of roaming between base stations in a wireless communication system by a subscriber, the method comprising the subscriber:
transmitting uplink signals to an original base station, the uplink signals being unexpected by the original base station;
selecting a new base station different from the original base station due to the subscriber failing to receive an acknowledgement to a predetermined number of transmitted uplink signals from the original base station; and
transmitting a new uplink signal to the new base station after having selected the new base station.

2. The method of claim 1, wherein selecting the new base station comprises eliminating the original base station from being a candidate for selection during the step of selecting the new base station.

3. The method of claim 1, wherein selecting the new base station comprises:
ranking a plurality of available base stations based on service level and, within each service level, based on radio measurements; and
selecting a highest ranked available base station out of the plurality of available base stations as the new base station, the highest ranked available base station having the best service level out of the plurality of available base stations.

4. The method of claim 3, wherein selecting the new base station further comprises removing the potential for the original base station to be selected as the new base station by artificially reducing the service level of the original base station to a lowest service level.

5. The method of claim 4, further comprising the subscriber restoring the service level of the original base station to its original value after selection of the new base station.

6. The method of claim 4, further comprising the subscriber restoring the service level of the original base station to its original value after a preset, non time-based condition has been met.

7. The method of claim 6, wherein the preset, non time-based condition is the selection of the new base station such that the service level of the original base station is restored immediately after the selection of the new base station.

8. The method of claim 6, wherein the preset, non time-based condition is receiving an acknowledgment to the new uplink signal from the new base station.

9. The method of claim 4, further comprising the subscriber restoring the service level of the original base station to its original value after a predetermined time period has elapsed, the predetermined time period set to (i) be greater than the mean historical time to correct failures in the original base station or in available base stations, or (ii) permit selection of the original base station at a time when less communication traffic is likely to exist on the original base station.

10. The method of claim 4, further comprising the subscriber:
retaining in memory a history of a number of times in which acknowledgments were not received from the original base station for uplink signals transmitted to the original base station within one or more established time periods and within a recent period for the original base station;
adjusting, based on the history of the original base station, a time period to form an adjusted time period; and
restoring the service level of the original base station to its original value after the adjusted time period has elapsed.

11. The method of claim 4, further comprising the subscriber:
determining whether one of the original and new base station has become relinquishable based on radio measurements of the one of the original and new base station; and
if the one of the original and new base station has become relinquishable, selecting a next base station different from the one of the original and new base station.

12. The method of claim 11, wherein selecting the next base station occurs without altering the service level of the one of the original and new base station.

13. The method of claim 1, wherein transmitting the uplink signals to the original base station comprises transmitting an uplink signal a limited number of times without receiving an acknowledgment from the original base station, wherein selection of the new base station is performed only after the limited number is reached.

14. The method of claim 13, further comprising the subscriber adjusting a counter towards the limited number for each transmitted uplink signal that is not acknowledged by the original base station, and adjusting the counter away from the limited number for each transmitted uplink signal that is acknowledged by the original base station.

15. The method of claim 1, further comprising the subscriber sending a communication containing information regarding the subscriber failing to receive an acknowledgement to a predetermined number of transmitted uplink signals from the original base station to a host located within an infrastructure of the communication system, via the new base station, to alert the host that an uplink failure has occurred with respect to the original base station.

16. An intelligent subscriber comprising:
a transmitter configured to transmit an unexpected uplink signal to an original base station in an infrastructure of a communication system;
a receiver configured to receive an acknowledgment corresponding to the unexpected uplink signal from the original base station;
a processor configured to execute programming instructions; and
a non-transitory computer readable medium containing the programming instructions,
wherein the programming instructions, when executed by the processor, cause the processor to determine whether the original base station has failed to acknowledge a predetermined number of unexpected uplinks signals transmitted from the transmitter to the original base station and thus that terminal failure of the original base station has occurred and, if terminal failure of the original base station has occurred, to select a new base station different from the original base station.

17. The subscriber of claim 16, wherein the programming instructions, when executed by the processor, cause the processor to (i) rank available base stations based on service level and, within each service level, based on radio measurements, (ii) select a highest ranked available base station as the new base station, and (iii) artificially reduce a service level of the original base station to a lowest service level after terminal failure of the original base station and before selection of the new base station.

18. The subscriber of claim 17, wherein the programming instructions, when executed by the processor, cause the processor to restore the service level of the original base station to its original value after selection of the new base station and before a terminal failure of the new base station.

19. The subscriber of claim 17, wherein the programming instructions, when executed by the processor, cause the processor to:
determine whether one of the original and new base station has become relinquishable based on radio measurements of, the one of the original and new base station; and
if the one of the original and new base station has become relinquishable, selecting a next base station different from the one of the original and new base station.

20. The subscriber of claim 16, wherein the programming instructions, when executed by the processor, cause the processor to sends a communication containing information regarding the terminal failure of the original base station to a host located within the infrastructure, via the new base station, to alert the host that terminal failure of the original base station has occurred.
